(19) United States
(12) Patent Application Publication
(10) Pub. No.: US 2007/0150916 A1
(43) Pub. Date: Jun. 28, 2007

(54) Using sensors to provide feedback on the access of digital content

(76) Inventors: James Begole, San Jose, CA (US); James Thornton, Redwood City, CA (US)

Correspondence Address: MARGER JOHNSON & MCCOLLOM/PARC, 210 MORRISON STREET, SUITE 400, PORTLAND, OR, 97204, US

(21) Appl. No.: 11/319,641

(22) Filed: Dec. 28, 2005

(51) Int. Cl. H04H 9/00; G06K 9/00; H04N 7/16

(52) U.S. Cl. 725/10; 725/12; 382/115; 382/116

(57) ABSTRACT

A system according to the present disclosure presents content to a user and provides feedback to a content provider without requiring the viewer to explicitly take action. A content presentation unit, such as a digital picture frame or public display, may be any device that continuously and/or sequentially displays graphical, audio and other presentations that may be sensed by a user, generally without intervention by the user. The unit may include sensors that detect when a human expresses interest in specific content, and in various embodiments, determines a type of emotional response experienced by the user regarding the content. Particular sensors may include eye-contact, touch, motion and voice, though other sensors may also be used. The response information can be combined to provide feedback to the content provider that the content was experienced, and may determine various data, such as the duration of attention to the content and any detected emotional response to it.

### TECHNICAL FIELD

This disclosure generally relates to electrical computers and digital data processing systems, and in particular it relates to devices having audio, visual and/or tactile sensors for monitoring user response to content.

### BACKGROUND OF THE DISCLOSURE

A digital picture frame or public display is a device that may continuously and/or sequentially display graphical content, generally without intervention by a user viewing the content. The digital picture frames marketed by CEIVA or VIALTA, for example, download new images over a network connection and/or from a computer, camera or similar device. In such systems, the user can not physically interact with the picture frames in such a way to provide feedback to the provider of content downloaded over the network connection. Therefore, a provider, or other sender, of the content may not be able to determine which items of the content are most appealing to the user. Content providers can receive feedback only by other means, such as separately contacting the user, or by having someone observe the user at the time of viewing. All of these require explicit actions taken by various parties to collect the information.

Many systems have been proposed to monitor a user's attention to a display device, using eye gaze monitoring sensors and/or speech recognition. Holman, Vertegaal, et al. describe the implementation of a 50″ plasma display that tracks eye gaze direction at 1-2 meters distance without calibration. David Holman, Roel Vertegaal, Changuk Sohn, and Daniel Cheng, “Attentive Display: Paintings As Attentive User Interfaces,” CHI '04 Extended Abstracts, pp 1127-1130. The luminance of regions in an art image on the display is changed depending on eye gaze fixation times recorded by various different viewers of the art work.

In 1986, Furnas described the real-time modification of a computer display to emphasize the portions that the user is paying attention to in an ‘attention-warping display’. In that work, cursor position is used to determine attention. Furnas, George, “Generalized Fisheye Views, Human Factors In Computing Systems,” CHI '86 Conference Proceedings, ACM, New York, pp. 16-23 (1986).

U.S. Patent Publication No. 20040183749 to Vertegaal describes the use of eye contact sensors to provide feedback in telecommunications to remote participants of each party's attention by monitoring eye contact.

U.S. Patent Publication No. 20020141614 to Lin teaches enhancing the perceived video quality of a portion of a computer display corresponding to a user's gaze.

U.S. Pat. No. 6,152,563 to Hutchinson et al. and U.S. Pat. No. 6,204,828 to Amir et al. teach systems for controlling a cursor on a computer screen based on a user's eye gaze direction.

U.S. Pat. No. 6,795,806 to Lewis, et al. describes the use of eye contact to a target area to differentiate between spoken commands and spoken dictation in a speech recognition system for the specific purpose of differentiating computer control from text input.

However, none of these prior systems allow for feedback of an emotional response by a particular user to the content, which may be determined and transmitted to the original content provider. Accordingly, there is a need for a method and apparatus for using sensors to provide feedback on the access of digital content that addresses certain shortcomings of existing technologies.

### SUMMARY OF THE DISCLOSURE

The present disclosure, therefore, introduces a content presentation device with various sensors that detect when a user expresses an emotional response to specific content. Sensors may include any one or more of: eye gaze detectors, touch and motion sensors, and voice sensors, though other sensors may also be used. The eye gaze detector may detect when the eyes of a user are directed at a target area of the content presentation data, using retinal reflection identification or the like. Touch and motion sensors may be used to detect when a user physically contacts or gestures towards the content presentation device in a manner that indicates positive or negative emotional reactions to the content. Voice sensors in combination with voice recognition and/or analysis software can detect the utterance of keywords, which may correspond to content in the presentation as defined by metadata associated with the image (e.g., people's names, relations, setting of the image, specific elements in the image, etc.). Voice recognition may also detect some emotional aspects of utterances, such as tonality or detected keywords. This emotional response information can be analyzed, either at the content presentation device or remotely, to provide feedback to the content provider (such as that a unit of content was seen, the duration of attention to a unit of content, and the emotional response to the content by the user) who may use the information to alter a frequency of or eliminate the presentation of the content to the user, based on the feedback. In certain embodiments, the emotional response information sent to the content provider can be limited based on privacy policies established by the user.

Accordingly, a system of the present disclosure provides emotional response data to a content provider without requiring the user to take explicit action to generate and transmit such feedback to the content provider. The sensor data may be used to control the content presentation device directly, as well as to provide feedback to the content provider who may use it to modify the content that will be displayed to the user in the future.

### BRIEF DESCRIPTION OF THE DRAWINGS

Further aspects of the present disclosure will be more readily appreciated upon review of the detailed description of its various embodiments, described below, when taken in conjunction with the accompanying drawings, of which:

FIG. 1 is a diagram of an exemplary network for transmitting content from content providers to users, according to various embodiments of the present disclosure;

FIG. 2 is a diagram of exemplary components of the content presentation unit of FIG. 1; and

FIG. 3 is a flowchart of an exemplary presentation and user feedback process performed in conjunction with the content presentation unit of FIG. 1.

### DETAILED DESCRIPTION OF THE SPECIFIC EMBODIMENTS

The correlation between sensed information (e.g., eye fixation, verbal comments and gestures) and a user's preference for content is the subject of continuing research, though it has been shown that a user's visual fixation, certain identifiable gestures and verbal comments correspond directly with the user's interest or disinterest in content. Using this principle, a content presentation device of the present disclosure presents content (which may be any of a wide variety of media types) to a user and includes one or more sensors for determining the user's response to the content and transmitting data corresponding to the response to the content provider. Such sensors may include an eye gaze detector to detect visual attention to the content presentation unit, a touch sensor to detect physical attention to the content presentation unit, a microphone used to record audio responses to the content, a motion sensor to identify gestures made near the content presentation unit, and the like.

Advantageously, the provider of the content may be made aware of a user's interest in the content without requiring specific user interaction with the controls of the content presentation unit. That is, in the example of a digital picture frame embodiment, a user does not need to intentionally interact with any input devices of the frame to indicate that they have seen content sent to the digital picture frame by a content provider, although such functionality may be included in the various embodiments described herein. Additionally, the content provider does not need to ask the user if they have seen the content, since feedback information is automatically provided by the digital picture frame. Furthermore, the sensors provide some information that may indicate the user's level of interest in certain content, and their emotional response to it.

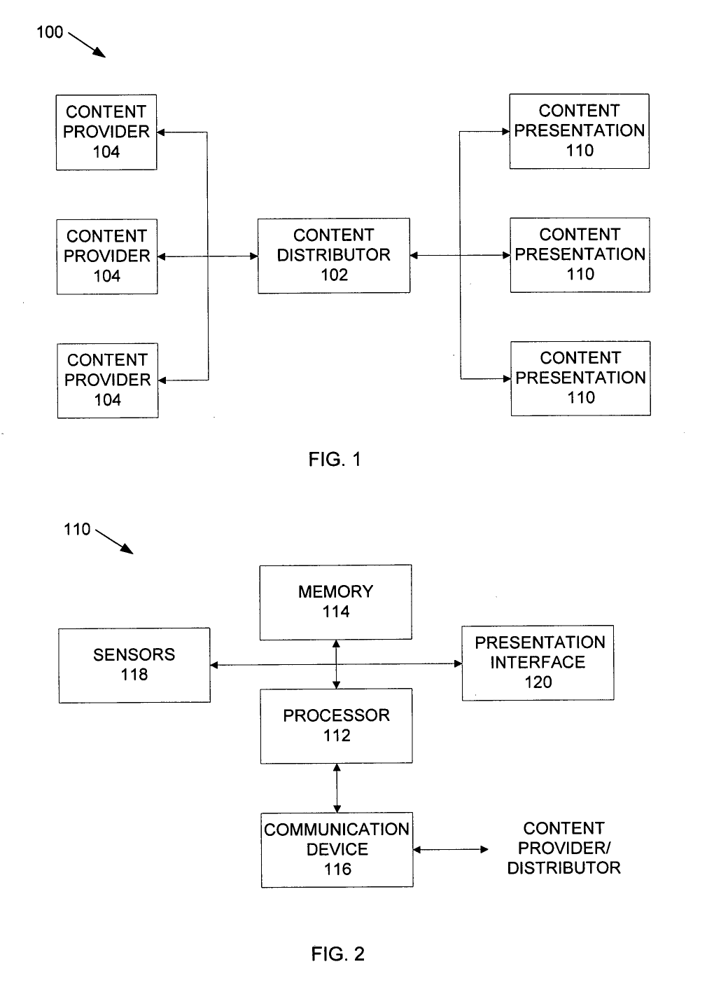

Referring now to FIGS. 1-3, wherein similar components of the present disclosure are referenced in like manner, various embodiments of a system for using sensors to provide feedback on emotional response to digitally-transmitted content will now be described in particular detail.

Referring now to FIG. 1, a system according to the present disclosure may be embodied in a variety of manners. For example, the system may include a network 100 over which a content provider 104 may transmit content to a content presentation unit 110 of a user. The content may be transmitted directly or through a content distributor 102. In certain exemplary embodiments, the content 104 provider transmits content using a personal computer or the like connected to the content distributor 102 and/or the content presentation unit 110 over the Internet. In such embodiments, the content distributor 102 may be an Internet web site or other network server, which receives content from content providers 104 and routes the content to desired content presentation units 110. In these embodiments, the content distributor 102 may receive and route response data from the content presentation units 110 to the appropriate content providers 104. Alternatively, or in addition to the foregoing, the content presentation unit 110 may communicate response data, of various types as described herein below, directly to the content providers 104 over any of a variety of useful networks which may operate as the network 100. In addition, it is contemplated that, in some instances, content may be physically sent to the user, for example, by mailing electronic or optical media containing the content, in place of network communication of the content.

Turning now to FIG. 2, there is depicted a block diagram of the components of an exemplary content presentation unit 110. In general, a suitable content presentation unit 110 may have the following components: a processor 112, a memory 114, a communication device 116, one or more sensors 118 and a presentation interface 120.

The processor 112 may be any processing device that responds processing instructions to coordinate the operation of the memory 114, sensors 118 communication device 116 and user interface 120 to accomplish the functionality described herein. Accordingly, the processor 112 may be any microprocessor of the type commonly manufactured by INTEL, AMD, SUN MICROSYSTEMS and the like.

The memory 114 may be any electronic memory device that stores content received from the communication device 116, as well as processing instructions for execution by the processor 112 and data from the sensors 118, which may be processed by the processor 112 to determine emotional responses to the content. Such memory devices 114 may include random access and read-only memories, computer hard drive devices, and/or removable media, such as read only or rewriteable compact disk and digital video disc technologies. Any other useful memory device may likewise be used.

The communication device 116 may be any type of device that allows computing devices to exchange data. For example, the communication device 116 may be a dial-up modem, a cable modem, a digital subscriber line modem, or any other suitable network connection device. The communication device 116 may be wired and/or wirelessly connected to the network 100.

The one or more sensors 118 may include any of the sensors now described herein below. One preferred sensor that may be used as sensor 118 is an eye gaze detector, which for example, identifies when eyes are directed at the content presentation unit 110. Such eye gaze detectors may or may not be sufficiently precise to track precise eye gaze location. The incidents and durations of eye contact directed to the content, or individual portions of the content, are recorded along with the identity of the content, or an item thereof, that was displayed during the eye contact.

Suitable eye gaze detectors are described, inter alia, in U.S. Pat. No. 6,393,136 to Amir et al. and U.S. Pat. No. 4,169,663 to Murr, which may be used in conjunction with the present disclosure. Additional eye gaze sensors described herein may likewise be used.

Alternatively, or in addition to the previously described sensors, the sensors 118 may include one or more microphones that capture audio, and particularly verbal or tonal responses of a user in the vicinity of the content presentation unit 110. The audio capture may be continuous or triggered by incidents of eye contact or other events. Similarly, an audio sensor may be used to trigger any additional component of the content presentation unit 100. Sensed audio may be analyzed, for example, to determine the presence of keywords that correlate with an emotional response to the content being presented. Voice recognition can detect the utterance of such keywords, which may, in various embodiments, correspond to image content as defined by associated meta-information (e.g., names, relations, setting, or other specific attribute) as may be associated with the content by the content provider 104.

Alternatively, or in addition to the detection of keywords, some recognition of emotional state may be possible, for example, by detecting tonality of the response during utterances of the user. The incidents of low/high tonality responses may then be sent to the content provider 104. Additionally, the recorded utterance itself may be sent to the content provider 104. In various embodiments, the audio content may be analyzed, either locally by the content presentation device 110, or remotely by the content distributor 102 or the content provider 114 itself, using any of a wide variety of known emotional analysis software to infer the emotional state of the user when the utterance was made. The emotional analysis result data may then be used by the content provider 104 to alter or eliminate the content presented to the user.

The following papers describe analysis techniques for detecting emotional characteristics in speech, any of which may be adapted for use in conjunction with the present disclosure:

K. R. Scherer, “Vocal Communication Of Emotion: A Review Of Research Paradigms,” Speech Communication, vol. 40, no. 1-2 (2003), pp. 227-256.

F. Dellaert, T. Polzin, and A. Waibel, “Recognizing Emotion In Speech,” Proc. 4th ICSLP, IEEE (1996), pp. 1970-1973.

A. Batliner, K. Fisher, R. Huber, J. Spilker, and E. Noth, “Desperately Seeking Emotions: Actors, Wizards, And Human Beings,” Proc. ISCA Workshop on Speech and Emotion, ISCA (2000);

M. Schroeder, R. Cowie, E. Douglas-Cowie, M. Westerdijk, and S. Gielen, “Acoustic Correlates Of Emotion Dimensions In View Of Speech Synthesis,” Proc. 7th EUROSPEECH, ISCA (2001), pp. 87-90;

C. M. Lee, S. Narayanan, and R. Pieraccini, “Combining acoustic and language information for emotion recognition,” Proc. 7th ICSLP. ISCA (2002), pp. 873-876; and

R. Cowie, E. Douglas-Cowie, N. Tsapatsoulis, G. Votsis, S. Kollias, W. Fellenz, and J. G. Taylor, “Emotion Recognition In Human-Computer Interaction,” IEEE Signal Processing Mag., vol. 18, no. 1 (2001), pp. 32-80.

Since a person may touch, point at or otherwise gesture at content, indicating interest, the sensors 118 may, alternatively or in addition to any combination of the foregoing sensors, may include any on or more of a variety of touch sensors, such as well-known capacitive or thermal elements disposed on or in the frame or within a display screen (e.g., a touch-responsive screen) of the content presentation unit 110. Any of a wide variety of known motion sensors or visual or infrared cameras may be included for monitoring user motions and positive/negative gestures (e.g., the user points at the content or blocks their field of view using their hand).

The sensors 118 can serve conventional sensing purposes as well, such as dimming a display when it is not being viewed, in order to save energy. Temporal patterns in the sensor data (such as identifying typical times a user views content or is not present) or ambient light, noise, or motion detectors may be used to proactively turn the display on or off in a variety of manners.

The content presentation unit 110 includes a content presentation interface 120 which presents the content to the user. The components comprising the content presentation interface 120 depends on the type of content to be provided to the user. In various embodiments, the content may include any one or more of a visual presentation, an audio presentation, a tactile presentation (such as vibration, other motion, or wind generation), an aromatic presentation, and a taste presentation. Accordingly, the content presentation interface 120 may include suitable components for presenting visual, audio, tactile and aromatic outputs to the user. For example, for visual content, the content presentation interface 120 may include a display device, such as a liquid crystal, cathode-ray tube, plasma, digital picture frame or other type of display. For audio content, the interface 120 may include one or more speakers, a headphone set and the like. A wide variety of known tactile and aromatic devices, or those under development, can be used alternatively or in combination with any of the foregoing components described. In addition, electronic taste presentation devices may be used, such as those described in Dan Maynes-Aminzade, “Edible Bits: Seamless Interfaces Between People, Data and Food”, Extended Abstracts of the 2005 ACM conference on Human Factors in Computing (CHI 2005), pp. 2207-2210.

In various embodiments, the content presentation interface 120 presents content comprising one or more static images presented periodically, continuously, or in a sequence. The content may include one or more items for continuous/sequential presentation, or for addition to an existing sequence of items currently presented to the user. In additional embodiments, the content may include clips of motion video or the like. Other media forms may be used as content alternatively or in addition thereto, such as audio, tactile, scent, wind, and the like. Various techniques may be employed to present and collect reactions to any of these media forms.

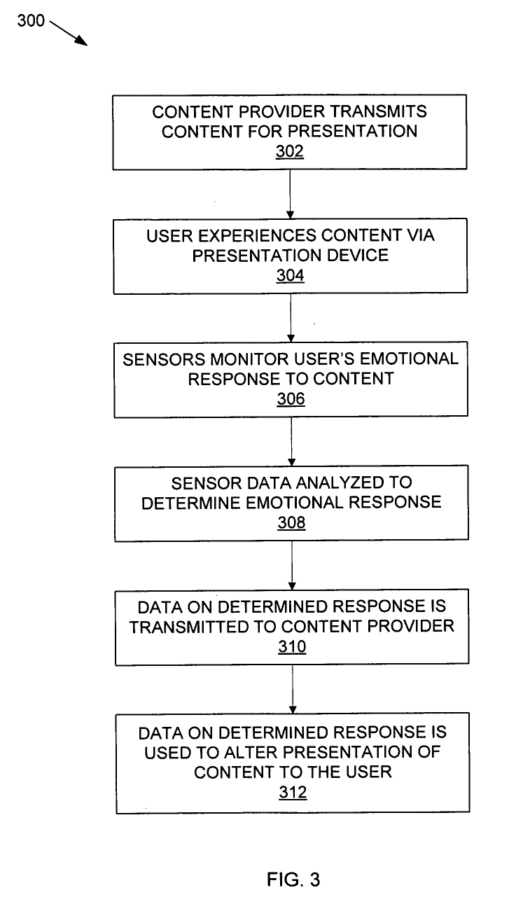

Referring now to FIG. 3, there is depicted an exemplary process 300 for monitoring, analyzing and transmitting a user's emotional response to received content, as may be performed by the content presentation unit 110 in the various embodiments described above. The process 300 commences when a content provider 104 transmits content for presentation to the content presentation unit 110 (step 302). The user then experiences the content via the content presentation interface 110 (step 304). Next, the sensors 118 monitor the user's emotional response to content, or individual items of the content (step 306). The sensor data is collected and then analyzed to determine emotional responses (step 308). This step may be performed locally by the processor 112 in accordance with suitable programming instructions, or the sensor data may be transmitted to the content distributor 102, content provider 104, or any other third party for analysis.

The analyzed or raw data is provided to the content provider 104 at step 310. The information may be sent immediately or recorded and sent in a batch mode. Finally, at step 312, the content provider 104 uses the received data on the user's emotional response to alter presentation of content to the user. For example, the content provider 104 may alter (e.g., increase or decrease) a frequency of sequential presentation of an item of the content to the user, based on the determined (positive or negative) response of the user to the item. Alternatively, or in addition thereto, the content, or individual items thereof may be eliminated or replaced, based on the user's responses. The process 300 then ends.

In order to avoid a perception that reporting of emotional responses encroaches on a user's privacy, the content presentation unit 110 may allow a user to input and set a privacy policy which determines the type of data that can be provided to the content provider 104. For example, the user can, through an appropriate user interface (not shown) specify exactly what information may be collected and provided to others. In addition, the content presentation device can include a visual or other indicator to announce when it is sensing emotional responses. The unit 110 can also provide review mechanisms that allow information that can be reviewed by the user before it is sent to others.

Although the disclosure has been described with respect to content distributed to a single user, it is readily contemplated that content may be displayed at multiple sites to a plurality of users, such as in publicly viewed advertising sites (billboards, kiosks and the like). Incidents of attention to the content from various locations may be collected and sent to the content provider 104, and in further embodiments, may also be propagated to other viewers of the content, enabling a shared distributed experience. In such embodiments, when a unit 110 detects attention at one site it may open a communication channel with other sites allowing all parties to share the experience.

Although the best methodologies have been particularly described in the foregoing disclosure, it is to be understood that such descriptions have been provided for purposes of illustration only, and that other variations both in form and in detail can be made thereupon by those skilled in the art without departing from the spirit and scope thereof, which is defined first and foremost by the appended claims.

What is claimed is:

1. A method for providing feedback on user response to content, comprising:
receiving, from a content provider, content for presentation to a user;
presenting the content to the user;
sensing, using at least one sensor, a response of the user to the content; and
transmitting, to the content provider, data corresponding to the response of the user.

2. The method of claim 1, said receiving further comprising:
receiving, from the content provider, content having a plurality of items for sequential presentation to a user.

3. The method of claim 2, further comprising:
altering a frequency of sequential presentation of an item of the content to the user, based on a response of the user to the item determined from the at least one sensor.

4. The method of claim 1, said content comprising at least one of:
an audio presentation, a visual presentation, a tactile presentation, and an aromatic presentation.

5. The method of claim 1, said presenting further comprising:
presenting the content to the user using at least one of: a computing device and a digital picture frame.

6. The method of claim 1, said sensing further comprising:
sensing the response of the user using at least one of: an eye gaze sensor, a microphone, and a touch sensor.

7. The method of claim 1, said transmitting further comprising:
transmitting, to the content provider, data corresponding to the response in accordance with a privacy policy established by the user.

8. The method of claim 1, further comprising:
transmitting, to at least one of the content provider and a content distributor, the response sensed by the at least one sensor, whereby the response is analyzed and response data based on the response is generated.

9. The method of claim 1, further comprising:
analyzing the response sensed by the at least one sensor; and
generating response data based on said analyzing, whereby the response data is transmitted to the content provider.

10. The method of claim 1, said presenting, further comprising:
presenting the content to a plurality of users.

11. The method of claim 1, said transmitting further comprising:
transmitting the response data to at least one other user that received the content from the content provider.

12. A method for presenting content based on user response, comprising:
receiving, from a content provider, content having a plurality of items for sequential presentation to a user;
presenting the content to the user;
sensing, using at least one sensor, a response of the user to an item of the content; and
altering a frequency of the presentation of the item to the user, based on the response sensed by the at least one sensor.

13. The method of claim 12, said content comprising at least one of:
an audio presentation, a visual presentation, a tactile presentation, and an aromatic presentation.

14. The method of claim 12, said presenting further comprising:
presenting the content to the user using at least one of: a computing device and a digital picture frame.

15. The method of claim 12, said sensing further comprising:
sensing the response of the user using at least one of: an eye gaze sensor, a microphone, and a touch sensor.

16. The method of claim 12, said transmitting further comprising:
transmitting, to the content provider, data corresponding to the response in accordance with a privacy policy established by the user.

17. The method of claim 12, further comprising:
transmitting, to the content provider, data corresponding to the response of the user.

18. The method of claim 12, said transmitting further comprising:
transmitting, to at least one of the content provider and a content distributor, the response sensed by the at least one sensor, whereby the response is analyzed and response data based on the response is generated.

19. The method of claim 12, further comprising:
analyzing the response sensed by the at least one sensor; and
generating response data based on said analyzing, whereby the response data is transmitted to the content provider.

20. The method of claim 12, wherein the content comprises a single item for addition to an existing sequence of items presented sequentially to the user.

21. An apparatus for presenting content to a user, comprising:
a communications device for receiving content from and transmitting feedback data to a content provider;
a presentation device for presenting the content to a user;
a plurality of sensors for monitoring a response of the user to the content and generating sensor data corresponding thereto;
a memory for storing the sensor data; and
a processor for processing the sensor data to provide feedback to the content provider on the presentation of the content.

22. The apparatus of claim 21, the presentation device further comprises a digital picture frame.

23. The apparatus of claim 21, the processor further for determining an emotional response of the user to the item based on the sensor data.
